(19) United States
(12) Patent Application Publication
(10) Pub. No.: US 2010/0202953 A1
(43) Pub. Date: Aug. 12, 2010

(54) SAND, SHALE AND OTHER SILICON DIOXIDE SOLID COMPOUNDS AS STARTING SUBSTANCES FOR PROVIDING SILICON SOLID COMPOUNDS, AND CORRESPONDING PROCESSES FOR OPERATING POWER STATIONS

(75) Inventor: Florian Krass, Weggis (CH)

Correspondence Address: DUANE MORRIS LLP - (prev. San Francisco);IP DEPARTMENT, 30 SOUTH 17TH STREET, PHILADELPHIA, PA, 19103-4196, US

(73) Assignee: SILICON FIRE AG, Meggen (CH)

(21) Appl. No.: 12/447,652

(22) PCT Filed: Oct. 26, 2007
(86) PCT No.: PCT/EP07/61574

§ 371 Date: Mar. 31, 2010

(30) Foreign Application Priority Data
Oct. 29, 2006 (EP) 06022578.6

(51) Int. Cl. C01B 21/068; C01B 31/36

(52) U.S. Cl. 423/346; 423/324; 423/344

(57) ABSTRACT

A process for providing silicon compounds from a silicon dioxide compound, preferably sand, with the following steps:
a) introducing the silicon dioxide compound into a combustion zone;
b) heating the combustion zone together with the silicon dioxide compound;
c) conversion of silicon dioxide from the silicon dioxide compound into silicon (Si₂), wherein a reducing agent is supplied in order to remove the oxygen from the silicon dioxide;
d) injecting a gaseous reaction partner in order to produce the silicon compound from the silicon (Si₂).

### CROSS-REFERENCES TO RELATED APPLICATIONS

The present application claims the priorities of the Patent Cooperation Treaty Application No. PCT/EP2007/061572, as filed on Oct. 26, 2007;

European Patent Application No. EP 06 022 578.6, as filed on Oct. 29, 2006, which are both incorporated herein by reference in their entirety for all purposes.

### BACKGROUND OF THE INVENTION

Currently, research and development are pursued in large number of directions in order to find a way to reduce anthropogenic CO₂ emissions. Especially in connection with power generation which frequently occurs by burning fossil fuels such as coal or gas, and also in other combustion processes such as waste incineration, there is a high demand for CO₂ reduction. Hundreds of millions of tons of CO₂ are emitted by such processes into the atmosphere.

The combustion substances used for generating heat typically produced CO₂. Up until now, no-one had thought of using sand (SiO₂), shale and other silicon-dioxide-containing substances (such as oil-bearing sand, oil-bearing shale (SiO₂+[CO₃]²), in bauxite or tarry sands or shales, and other mixtures of sand) in order to obtain (thermal) energy in power station or power-station-like processes. This approach would be especially advantageous if the emission of CO₂ could be reduced or eliminated. It would further be ideal if products could be provided in such processes or power stations which could be used as “raw materials” for downstream processes or installations.

The stores of sand and shale and especially oil-bearing sands (SiO₂) and shale (SiO₂+[CO₃]²) are enormous.

Sand is a naturally occurring, loose sedimentary rock and can be found all over the earth's surface in more or less high concentration. A large portion of the sand deposits consist of quartz (silicon dioxide; SiO₂).

It is the object of the present invention to determine such potential raw materials and to describe their technical preparation. The chemical considerations used in the process are characterized in that the SiO₂ present in the sand and shale and other mixtures takes part in a reaction (in a power-station process), with the SiO₂ being changed chemically by way of a reaction into one or several compounds.

Further embodiments of the invention are characterized by the following features aspects:

1) Silicon (Si) can be provided from sand or other SiO₂ mixtures by combustion or reaction together with liquid aluminum or hot aluminum dust. The reaction runs as follows in a highly simplified illustration:

SiO₂+Al→Si+Al₂O₃

2) The heat released in a furnace during the thermal reaction of the main process can drive the turbine of a dynamo, e.g. by means of highly compressed steam.

3) The most important ceramic materials of silicon nitride (Si₃N₄: with its diamond-like hardness) and silicon carbide (SiC: with its remarkable thermal conductivity) can be produced in a cost-effective and simple way as raw materials.

4) If necessary, the crystalline silicon (e.g. as a powder at suitable temperature) can be converted directly with pure (cold) nitrogen (e.g. nitrogen from ambient air) or with nitrogen radicals into silicon nitride. This reaction is highly exothermic. The heat obtained here as described in para 2) above for example can be used. A process for obtaining nitrogen can be used for example which is known from steel refining with propane gas (propane nitration).

Further details and advantages of the invention will be described below by reference to embodiments.

### BRIEF SUMMARY OF THE INVENTION

[symbol]

### BRIEF DESCRIPTION OF THE DRAWINGS

[symbol]

### DETAILED DESCRIPTION OF THE INVENTION

The invention will be described below by reference to examples. A first example relates to the application of the invention in power-station operation in order to “combust” sand with nitrogen in order to use (exhaust) heat for power generation in this new form of generating power. This novel approach to a power station reduces or eliminates the CO₂ emissions that occurred up until now.

In accordance with the invention, a series of purposefully performed chemical reactions are involved, in which new chemical compounds (called products) are obtained from the starting substances (also called educts or reactants). The reactions according to the invention of the process initially designated as main process are designed in such a way that nitrogen-based “combustion” of SiO₂ occurs.

Sand (which can be laced with mineral oil for example as a primary energy supplier) or shale is used for example as a starting substance in a first embodiment. These starting substances are supplied to a reaction chamber in the form of an afterburner or a combustion chamber for example. A reducing agent is injected or introduced into this chamber and the chamber with the silicon dioxide compound is brought to high temperatures (preferably temperatures which are higher than 1000° C., preferably approximately 1350° C.). As a result, oxygen is split off from the silicon dioxide and highly reactive silicon is present. By injecting or introducing a gaseous reaction partner (e.g. nitrogen or carbon dioxide), a silicon compound can be produced from the silicon. The conversion into a silicon compound is typically exothermic to highly exothermic, which means that heat is released. This heat can be used, like in other known power station processes, for power generation or for conversion into electric or mechanical energy.

In a preferred embodiment, CO₂ is injected as a gaseous reaction partner into this chamber. This CO₂ can be the CO₂ exhaust gas which is obtained in large quantity in power generation from fossil fuels and which has been released into the atmosphere in many cases until now. In addition, (ambient) air is supplied to the chamber. Instead of the ambient air, or in addition to the ambient air, steam or hypercritical H₂O over 407° C. can be supplied to the process. The silicon in the combustion chamber reacts with the CO₂ into silicon carbide (SiC). This reaction is slightly exothermic.

Furthermore or alternatively, the injection of nitrogen is to be provided at another location in the process or the combustion chamber, respectively.

Moreover, a kind of catalyst is used as a reducing agent or reduction partner. Especially suitable is aluminum (fluid or powdery). Under suitable ambient conditions, a reduction occurs in the chamber, which can be illustrated as follows in a highly simplified way:

$$S i {O}_{2} {\to }^{r e d} S i$$

This means the percentage of quartz contained in the sand or shale is converted into crystalline silicon.

The mineral oil of the sands which is used can assume the role of supplier of primary energy and is then broken down itself in the process in accordance with the invention pyrolytically at temperatures over 1000° C. substantially into hydrogen (H₂) and a graphite-like compound. Hydrogen is extracted during the ongoing reactions of the hydrocarbon chains of the mineral oil. Hydrogen can be diverted to the piping system of the natural-gas industry or be stored in hydrogen tanks.

In a further embodiment, the invention is applied in connection with a pyrolysis process of Pyromex AG, Switzerland. The present invention can also be used in addition to or as an alternative to the so-called oxyfuel process. An energy cascade heat production can be performed according to the following approach. By modifying the oxyfuel process, heat is generated by adding aluminum, preferably liquid aluminum, and by adding nitrogen (N₂) (in analogy to the known Wacker accident). When nitrogen is coupled to silicon as required, preferably the pure nitrogen atmosphere from the ambient air is obtained by combustion of the oxygen share of the air with propane gas (as known from propane nitration).

In accordance with the invention, preferably aluminum (Al) is used as a reducing agent or reduction partner. Gaining aluminum profitably at the moment is only possible from bauxite. Bauxite contains approx. 60 percent of aluminum oxide (Al₂O₃), approx. 30 percent of iron oxide (Fe₂O₃), silicon oxide (SiO₂) and water, which means that bauxite is typically always contaminated with iron oxide (Fe₂O₃) and silicon oxide (SiO₂). Bauxite can therefore be used as a fuel or combustible in a power station in accordance with the invention, or bauxite can be added in a further step to sand or shale.

Due to the extremely high lattice binding energy, Al₂O₃ cannot be reduced chemically. From a technical standpoint, the production of aluminum is achieved by igneous electrolysis (cryolite/alumina process) of aluminum oxide Al₂O₃. Al₂O₃ is obtained for example through the Bayer process. In the cryolite/alumina process, the aluminum oxide is molten with cryolite (salt: Na₃[AlF₆]) and electrolyzed. In order to avoid having to work at high melt temperature of the aluminum oxide of 2000° C., the aluminum oxide is dissolved in a melt of cryolite. In the process, the working temperature lies at only 940 to 980° C.

In igneous electrolysis, liquid aluminum is produced at the cathode and oxygen at the anode. Carbon blocks (graphite) are used as anodes. These anodes burn off by the obtained oxygen and need to be replaced continually.

It is regarded as an essential disadvantage of the cryolite/alumina process that it requires a high amount of energy due to the high bond energy of the aluminum. The partly occurring formation and emission of fluorine is regarded as problematic for the environment.

In the process in accordance with the invention, the bauxite can be added to the process in order to achieve a cooling of the process. The excessive thermal energy in the system can be handled by the bauxite. This occurs in analogy to the process where iron scrap is added to an iron melt in a blast furnace when the iron melt becomes too hot.

Cryolite can be used in an auxiliary capacity if the process tends to go out of control (see Wacker accident) in order to reduce the temperature in the system within the terms of emergency cooling.

Like silicon carbide (SiC), silicon nitride (Si₃N₄) is a wear-proof material which is or can be used in heavy-duty parts in mechanical engineering, turbine construction, chemical apparatuses, and motor construction.

Further details for the described chemical courses and energy processes are shown on the following pages.

Silica sand can be converted with liquid aluminum in an exothermic way into silicon and aluminum oxide according to the textbook Holleman-Wiberg:

3SiO₂+4Al(l)→3Si+2Al₂O₃ ΔH=−618.8 kJ/mol

(exothermic)

Silicon burns with nitrogen into silicon nitride at 1350° C. The reaction is exothermic again.

$$T = 1350 ° C . \begin{matrix}3 S i + 2 {N}_{2} ( g ) \to {Si}_{3} {N}_{4} & Δ H = - 744 kJ \text{/} mol\end{matrix}$$

$$( exothermic )$$

Silicon reacts with carbon in a slightly exothermic way into silicon carbide.

Si+C→SiC ΔH=−65.3 kJ/mol

(exothermic)

On the other hand, silicon carbide can be obtained directly from sand and carbon at approx. 2000° C. in an endothermic way:

$$T = 2000 ° C . \\ S i {O}_{2} + 3 C ( g ) \to S i C + 2 C O Δ H = + 625.3 k J \text{/} mol \\ ( endothermic )$$

In order to recover aluminum again from the by-product bauxite or aluminum oxide Al₂O₃, fluid Al₂O₃ (melting point 2045° C.) is electrolyzed without any addition of cryolite into aluminum and oxygen. The reaction is highly endothermic and is used for cooling the exothermic reactions.

2Al₂O₃(l)→Al(l)+3O₂(g) ΔH=+1676.8 kJ/mol

(endothermic)

According to a further embodiment of the invention, a thermite reaction (redox reaction) is used in which aluminum is used as a reduction agent in order to reduce iron (III) oxide to iron.

Fe₂O₃+2Al→>2Fe+Al₂O₃

The reaction products are aluminum oxide and elementary iron. The reaction occurs in a strongly exothermic manner and a large amount of heat is obtained. The combustion process is a highly exothermic reaction and up to 2500° C. are obtained. The aluminum and iron (III) oxide become liquid as a result of the achieved temperatures.

The reduction of silicon dioxide into silicon can be initiated or maintained by means of such a thermite reaction (aluminothermic reduction of silicon dioxide). The silicon dioxide also becomes liquid. Since burning thermite does not require any external oxygen, the reaction cannot be suffocated and can continue to burn in any environment, which means nitrogen can be supplied simultaneously without suppressing the reaction and in order to thus produce silicon nitride.

In order to support the conversion of silicon dioxide into silicon and the conversion (“combustion”) into silicon carbide or silicon nitride, the thermite reaction can be promoted from time to time by introducing aluminum and iron (III) oxide for example.

The production of silicon carbide and silicon nitride from oil-bearing sand is described below by way of example. It concerns a specific embodiment of the invention however.

Production of Silicon Carbide and Silicon Nitride from Oil Sand

### 1. Introduction and “Formula” for Oil Sand

The ceramic materials of silicon nitride Si₃N₄ and silicon carbide SiC can be obtained from an oil sand with approximately 30 percent by weight of crude oil via a multi-stage process. In order to deal in a stoichiometric useful manner with the chemically highly complex mixture of various hydrocarbon compounds which is known as crude oil, the formula C₁₀H₂₂ is used representatively for the crude oil, which formula actually stands for decane. Sand is a substance which is described precisely with the formula SiO₂ and stands with the crude oil contained therein at a weight ratio of 70% to 30%. Oil sand is therefore described with the formula SiO₂+C₁₀H₂₂ in a rough approximation, with SiO₂ having a molecular weight of 60 g/mol and decane a molecular weight of 142 g/mol. When 100 g of oil sand are used, there are 70 g of SiO₂ and 30 g of “decane” or crude oil. When one calculates the substance quantities of SiO₂ and “decane”, then one obtains the following for SiO₂:

$$n = \frac{70 g}{60 g \text{/} mol} \approx 1.167 mol S i {O}_{2}$$

And for crude oil:

$$n = \frac{30 g}{142 g \text{/} mol } \approx 0.211 mol {C}_{10} {H}_{22}$$

When both mole numbers are multiplied with 5, then one obtains 5.833 mol for SiO₂ and 1.056 mol for C₁₀H₂₂, leading to 6 mol of SiO₂ to one mol of C₁₀H₂₂. The formula 6SiO₂+“1” C₁₀H₂₂ can be used for oil sand in a favorable approximately.

### 2. Pathway of Synthesis

The preparation of silicon nitride Si₃N₄ from oil sand occurs as follows: Oil sand is heated at first together with dichloromethane CH₂Cl₂ in an oxygen-free atmosphere to 1000° C. Silicon changes the bonding partner and forms silicon tetrachloride according to equation (I):

6SiO₂+C₁₀H₂₂+12CH₂Cl₂→6SiCl₄+12CO+10CH₄+3H₃ (I)

In a second step, the obtained silicon chloride is hydrogenated at room temperature with lithium aluminum hydride [1], according to equation (II).

SiCl₄+LiAlH₄→SiH₄+LiAlCl₄ (II)

Finally, the obtained monosilane SiH₄ is combusted in pure nitrogen, equation (III):

3SiH₄+4N₂→Si₃N₄+4NH₃ (III)

In order to obtain SiC, one could also find a reaction pathway which is more favorable from an energetic viewpoint instead of the high-temperature reaction (equation IV) which occurs at 2000° C. and is energetically very complex.

SiO₂+3C→SiC+2CO (IV)

Starting material is again silicon tetrachloride SiCl₄ which is obtained from equation (I) and is converted with graphite or methane:

SiCl₄+CH₄→SiC+4HCl (V)

Or:

SiCl₄+2C→SiC+CCl₄ (VI)

### 3. Stoichiometric Calculations

When 1 kg of oil sand is used, then it contains 700 g of silicon dioxide and 300 g of “decan”. When calculated in amounts of mass, then n=11.67 mol is obtained for silicon dioxide and n=2.11 mol for “decan”.

According to equation (I), the following relative molar weights apply to the compounds:

6SiO₂+10C₁₀H₂₂+12CH₂Cl₂→6SiCl₄+12CO+10CH₄+3H₂ (I)

Mᵣ: 60 142 84 169.9 28 16 2 g/mol

Since the amount of mass for silicon tetrachloride SiCl₄ is the same due to the same stoichiometric factor, the following quantity of SiCl₄ results from 1 kg of oil sand:

m(SiCl₄)=11.67 mol·169.9 g/mol=1.982 of SiCl₄

Due to twice the amount of mass of CO as compared with SiO₂, a mass of CO is obtained which is:

m(CO)=2·11.67 mol·28 g/mol=653 g of CO

Due to 10 times the amount of mass of CH₄ as compared with “decan”, a mass of CH₄ is obtained which is:

m(CH₄)=10·2.11 mol·16 g/mol=338 g of CH₄

Due to half the amount of mass of H₂ as compared with SiO₂, a mass of H₂ is obtained which is:

m(H₂)=½·11.67 mol·2 g/mol=11.67 g of H₂

Since in equation (II) all stoichiometric factors are equal to one, the following applies further:

SiCl₄+LiAlH₄→SiH₄+LiAlCl₄ (II)

Mᵣ: 169.9 142 32 175.8 g/mol

### Therefore

m(LiAlH₄)=11.67 mol·38 g/mol=443.3 g of LiAlH₄

m(SiH₄)=11.67 mol·32 g/mol=373.3 g of SiH₄

m(LiAlCl₄)=11.67 mol·175.8 g/mol=187.5 kg of LiAlCl₄

Since in equation (III) the original amount of mass of silicon dioxide of 11.67 mol is still present and the amount of mass of Si₃N₄ as compared with that of SiH₄ is one-third, the following applies here:

3SiH₄+4N₂→Si₃N₄+4NH₃ (III)

Mᵣ: 28 140 17 g/mol

m(Si₃N₄)=⅓·11.67 mol·140 g/mol=544.4 g of Si₃N₄

The amount of mass of N₂ is 4/3 as compared with that of SiH₄. A mass is calculated from this as follows:

m(N₂)=4/3·11.67 mol·28 g/mol=435.5 g of N₂

Converted to volume, these 435.5 g of N₂ correspond at a molar volume of 22.4 liters to the following: V=348.4 liters of N₂.

The amount of mass of NH₃ is also 4/3 of the amount of mass of SiH₄:

m(NH₃)=4/3·11.67 mol·17 g/mol=264.4 g of NH₃

Converted to volume, these 264.4 g of NH₃ correspond at a molar volume of 22.4 liters to the following: V=348.4 liters of NH₃.

The initial amount of mass of 11.67 mol for silicon tetrachloride applies again to the equation (V):

SiCl₄+CH₄→SiC+4HCl (IV)

Mᵣ: 169.9 16 40 36.5 g/mol

### Therefore:

m(SiC)=11.67 mol·40 g/mol=466.6 g of SiC

m(CH₄)=11.67 mol·16 g/mol=186.7 g of CH₄

Converted to volume, these 186.7 g of CH₄ correspond at a molar volume of 22.4 liters to the following: V=261.3 liters of CH₄.

m(HCl)=4·11.67 mol·36.5 g/mol=1.703 kg of HCl

When calculated in metric tons, the unit g can be replaced by kg and kg by metric ton t. and liters by m³ without changing anything in respect of the numeric values.

The following thermodynamic variables apply to equation (I):

6SiO₂+C₁₀H₂₂+12CH₂C₁₂→6SiCl₄+12CO+10CH₄+3H₂ (I)

| | | C₁₀H₂₂ | CH₂ Cl₂ | | | | |
|---|---|---|---|---|---|---|---|
| | SiO₂ | (g) | (g) | SiCl₄ (g) | CO (g) | CH₄ (g) | H₂ (g) |
| Δh ° kJ/mol | −859.3 | −249.7 (g) | −117.1 | −577.4 | −110.5 | −74.85 | 0 |
| S ° J/mol Kelvin | 42.09 | 540.5 (g) | 270.2 | 331.4 (g) | 197.4 | 186.19 | 130.6 |
| Cₚ J/mol Kelvin | 44.43 | 243.1 (g) | 51.1 | 90.58 (g) | 29.15 | 35.79 | 28.83 |

The value for ΔH is calculated as follows:

ΔH=6·(−577.4)+12·(−110.5)+10 ·(−74.85)−6·(−859.3)−(−249.7)−12·(−117.1) kJ/mol, ΔH=+1271.8 kJ/mol

Equation (I) is thus a reaction progressing at room temperature in an endothermic way because ΔH>0.

The following value is obtained for AS:

ΔS=6·331.4+12·197.4+10·186.19+3·130.6−6·42.09−540.5−12·270.2 J/mol Kelvin, ΔS=+2575.46 J/mol Kelvin

Entropy is increased, so that equation (I) is promoted by the propulsive force of the entropy, and will presumably react towards the product side. In order to finally answer this question, the free enthalpy change ΔG needs to be calculated, with the following formula being used:

ΔG=ΔH−T·ΔS

The standardized 298 Kelvin are used for the temperature T. ΔG is thus:

+1271.8 kJ/mol−298 K−2575.46 J/mol K=+504.31 kJ/mol.

At room temperature, the free enthalpy change A is positive, which indicates that the reaction (I) runs endergonic at this temperature, which means it is not voluntary. The propulsive force of entropy is therefore insufficient to shift the reaction to the product side because the endothermic amount of the heat reaction counteracts the same too strongly.

But what is the effect of an increase of temperature on ΔH, ΔS and ΔG? For this purpose, ΔH (T=1300 K) and ΔS (T=1300 K) is calculated over the change of the thermal capacity ΔCₚ under isobaric conditions.

ΔCₚ=6·90.58+12·29.15+10·35.79+3·28.83−6·44.43−243.1−12·51.1 J/mol Kelvin, ΔCₚ=+214.79 J/mol Kelvin

ΔH(T=1300 K)=ΔH(T=298 K)+ΔCₚ(1300 K−298 K)=+1271.8 kJ/mol+214.79 J/mol K·1002 K=+1487 kJ/mol, the reaction remains endothermic.

ΔS(T=1300 K)=ΔS(T=298 K)+ΔCₚ·In(1300 K/298 K)=+2575.46 J/mol+214.79 J/mol·K·In(4.3624)=+2891.85 J/mol·K

ΔG(1300 K)=ΔH(1300 K)−T·ΔS(1300 K)=+1487 kJ/mol−1300 K·2891.85 J/mol·KΔG(1300 K)=−2272.41 kJ/mol, the reaction suddenly becomes exoergic at 1300 K.

The reaction can therefore occur at 1300 Kelvin.

The following thermodynamic variables apply to equation (II):

SiCl₄+LiAlH₄→SiH₄+LiAlCl₄ (II)

| | SiCl₄ | LiAlH₄ | SiH₄ | LiAlCl₄ |
|---|---|---|---|---|
| Δh° kJ/mol | −577.4 | −100.8 | −61.0 | −1114.15 |
| S° J/mol Kelvin | 331.4 (g) | ? | 204.5 | 225.2 |

ΔH=(−61.0)+(−1114.15)−(−577.4)−(−100.8) kJ/mol=−496.95 kJ/mol

Equation (II) is thus an exothermic reaction because ΔH<0.

The value of the enthropy change cannot be determined for ΔS, because the enthropy data for LiAlH₄ could not be found [2]. However, this reaction is described in “Textbook of Inorganic Chemistry” (Hollemann-Wiberg) [1] as occurring spontaneously or progressing exoergic at room temperature, which gives an indication that ΔG needs to be <0.

The following thermodynamic variables apply to equation (III):

3SiH₄+4N₂→Si₃N₄+4 NH₃ (III)

| | SiH₄ | N₂ | Si₃N₄ | NH₃ |
|---|---|---|---|---|
| Δh° kJ/mol | −61.0 | 0 | −750.0 | −46.19 |
| S° J/mol Kelvin | 204.5 (g) | 191.5 | 95.4 | 192.5 |

ΔH=(−750)+4·(−46.19)−3·(−61.0)−0 kJ/mol=−751.76 kJ/mol

Equation (III) is thus an exothermic reaction because ΔH<0.

The following value is obtained for ΔS:

ΔS=95.4+4·192.5−3·204.5−4·191.5 kJ/mol Kelvin

ΔS=−514.1 J/mol Kelvin, which means the reaction leads to a decrease in entropy.

With ΔG=ΔH−T··S the amount ΔG=−496.95 kJ/mol−298 K·(−514.1) J/mol K=−598.56 kJ/mol

At room temperature, free enthalpy AG is thus negative, which means that the reaction (III) at this temperature runs in an exoergic way, i.e. completely spontaneously or entirely voluntarily without any external force. An ignition temperature of approximately 900 Kelvin must be chosen merely due to activation energy required for breaking up the N₂ molecule in order to start the reaction. The reaction maintains itself afterwards without external influence.

The following thermodynamic variables apply to equation (V):

SiCl₄+CH₄→SiC+4HCl (V)

| | SiCl₄ | CH₄ | SiC | HCl |
|---|---|---|---|---|
| Δh° kJ/mol | −577.4 | −74.85 | −111.7 | −92.31 |
| S° J/mol Kelvin | 331.4 (g) | 186.19 | 16.46 | 186.9 |
| Cₚ J/mol Kelvin | 90.58 (g) | 35.79 | 26.65 | 29.12 |

ΔH=(−111.7)+4·(−92.31)−(−577.4)−(−74.85) kJ/mol=+171.31 kJ/mol

Equation (V) is thus an endothermic reaction because ΔH>0.

The following value is obtained for ΔS:

ΔS=16.46+4·186.9−331.4−186.19 kJ/mol Kelvin

ΔS=+246.47 J/mol Kelvin, which means an increase in entropy occurs!

With ΔG=ΔH−T·ΔS, the amount ΔG=+171.31 kJ/mol−298 K·246.47 J/mol K=+97.86 kJ/mol

The reaction at room temperature is both endothermic (ΔH>0) as well as endoergic (ΔG>0). It is thus unable to run at room temperature.

The following value is obtained for ΔCₚ:

ΔCₚ=26.65+4·29.12−90.58−35.79 J/mol·Kelvin=+16.76 J/mol·Kelvin

ΔH(T=1300 K)=ΔH(T=298 K)+ΔCₚ(1300 K−298 K)=+171.31 kJ/mol+16.76 J/mol·K·1002 K=+188.1 kJ/mol, the reaction remains endothermic.

ΔS(T=1300 K)=ΔS(T=298 K)+ΔCₚ·In(1300 K/298 K)=+246.47 J/mol K+16.76 J/mol·K·In(4.3624)=+271.16 J/mol·K

ΔG(1300 K)=ΔH(1300 K)−T·ΔS(1300 K)=+188.1 kJ/mol−1300 K·271.16 J/mol·K

ΔG(1300 K)=−164.4 kJ/mol, the reaction suddenly becomes slightly exoergic at 1300 K.

The reaction can therefore occur at 1300 Kelvin.

The following thermodynamic variables apply to equation (VI):

SiCl₄+2C→SiC+CCl₄ (VI)

| | SiCl₄ | C | SiC | CCl₄ |
|---|---|---|---|---|
| Δh° kJ/mol | −577.4 | 0 | −111.7 | −106.7 (g) |
| S° J/mol Kelvin | 331.4 (g) | 5.74 | 16.46 | 309.7 (g) |
| Cₚ J/mol Kelvin | 90.58 (g) | 8.53 | 26.65 | 83.4 (g) |

ΔH=(−111.7)+(−106.7)−(−577.4)−0 kJ/mol=+359.0 kJ/mol

Equation (IV) is thus an endothermic reaction at room temperature because ΔH>0.

The following value is obtained for ΔS:

ΔS=16.46+309.7−331.4−2·5.74 kJ/mol Kelvin

ΔS=−16.72 J/mol Kelvin, which means a slight decrease in entropy occurs!

With ΔG=ΔH−T·ΔS, the amount ΔG=+359.0 kJ/mol−298 K ·(−16.72) J/mol K=+364.0 kJ/mol

The reaction at room temperature is both endothermic (ΔH>0) as well as endoergic (ΔG>0). It is thus unable to run at room temperature. What is the situation at a temperature of 1300 Kelvin?

The following value is obtained for ΔCₚ:

ΔCₚ=26.65+83.4−90.58−2·8.53 J/mol·Kelvin=+2.41 J/mol·Kelvin

ΔH(T=1300 K)=ΔH(T=298 K)+ΔCₚ(1300 K−298 K)=+359.0 kJ/mol+2.41 J/mol·K·1002 K=+361.4 kJ/mol, the reaction remains endothermic.

ΔS(T=1300 K)=ΔS(T=298 K)+ΔCₚ·In(1300 K/298 K)=−16.72 J/mol Kelvin+2.41 J/mol·K·In(4.3624)=−13.17 J/mol·K

ΔG(1300 K)=ΔH(1300 K)−T·ΔS(1300 K)=+361.4 kJ/mol 1300 K·(−13.17 J/mol·K)

ΔG(1300 K)=+378.5 kJ/mol, the reaction remains unchanged endergonic also at 1300 K.

This last reaction illustrates in a convincing manner that it is not possible to shift every balance with an increase of temperature to the other side. Occasionally, things remain the same and the proposed reaction pathway needs to be dropped. This is the case here in this reaction.

### 5. Summary

The pathway of synthesis as described can be performed with the proposed reaction equations when the respective, thermodynamically favorable temperatures are maintained, with reaction (VI) representing the exception because it cannot occur at any of the calculated temperatures. Therefore, a clear pathway of synthesis is formed for the preparation of silicon nitride Si₃N₄ and silicon carbide SiC which will be described below again by adding the required operating temperatures. At first, the oil sand is heated together with dichloromethane (CH₂Cl₂) in an oxygen-free atmosphere to 1300 Kelvin (1000° C.). Silicon changes the bonding partner and forms silicon tetrachloride according to equation (I):

T=1300 K

6SiO₂+C₁₀H₂₂+12CH₂C₁₂→6SiCl₄+12CO+10CH₄+3H₂ (I)

In a second step, the obtained silicon chloride is hydrogenated with lithium aluminum hydride [1], according to equation (I).

T=298 K

SiCl₄+LiAlH₄→SiH₄+LiAlCl₄ (II)

Finally, the obtained monosilane SiH₄ is combusted in pure nitrogen (equation (III)), with the ignition temperature being an estimated 600 K above room temperature due to the activation energy required for breaking up the nitrogen molecule.

T≈900 K

3SiH₄+4N₂→Si₃N₄+4NH₃ (III)

In order to obtain silicon carbide SiC, silicon tetrachloride SiCl₄ is used as a basis which is obtained from equation (I), and it is converted with methane at 1300 K:

T=1300 K

SiCl₄+CH₄→SiC+4HCl (V)

Instead of the monosilane obtained in equation (I), it is also possible to obtain higher silylchlorides according to [1] via polymerization reactions of SiCl₂ and also higher silanes by subsequent hydrogenation with LiAlH₄, as are shown in the following reaction equations:

T=1250° C.

SiCl₄+Si→2SiCl₂ (VII)

SiCl₄+SiCl₂→Si₂Cl₆ (VIII)

SiCl₄+2SiCl₂→Si₃Cl₈ (IX)

etc.

4Si₂Cl₆→Si₅Cl₁₂+3SiCl₄ (X)

5Si₂Cl₆→Si₆Cl₁₄+4SiCl₄ (XI)

etc.

2Si₂Cl₆+3LiAlH₄→2Si₂H₆+3LiAlCl₄ (XII)

Si₅Cl₁₂+3LiAlH₄→Si₅H₁₂+3LiAlCl₄ (XIII)

etc.

Higher silanes (from Si₇H₁₆) offer the advantage that they are no longer pyrophoric and can be combusted in a much more controlled manner than SiH₄. Accordingly, combustion with pure nitrogen is preferable when higher silanes reach this reaction.

The production of silicon carbide and silicon nitride from oil-bearing sand is described below by reference to a further embodiment. It concerns a specific embodiment of the invention however.

### 1) Combustion of Oil Sand:

In order to determine oil sand in an approximate stoichiometric manner, the chemically comprehensible formula 6SiO₂+C₁₀H₂₂ or 12SiO₂+2C₁₀H₂₂ is used. The following thermodynamic variables apply to equation (I) or (II):

12SiO₂+2 C₁₀H₂₂+31O₂→12SiO₂+20CO₂+22H₂O (I)

In short:

2C₁₀H₂₂+31O₂→20CO₂+22H₂O (II)

| | C₁₀H₂₂ (g) | O₂ (g) | CO₂ (g) | H₂O (g) |
|---|---|---|---|---|
| Δh° kJ/mol | −249.7 (g) | 0 | −393.77 | −241.8 |
| S° J/mol Kelvin | 540.5 (g) | 205.0 | ? (g) | 188.65 |
| Cₚ J/mol Kelvin | 243.1 (g) | 29.36 | ? (g) | 33.56 |

The value for ΔH is calculated as follows:

ΔH=20·(−393.77)+22·(−241.8)−2·(−249.7) kJ/mol, ΔH=−12,695.6 kJ

Equation (I) is thus a reaction that runs in a clearly exothermic manner at room temperature because ΔH<<0.

2) Reduction of Silicon Dioxide with Aluminum:

The following thermodynamic variables apply to equation (III):

12SiO₂+16Al→12Si+8Al₂O₃ (III)

| | SiO₂ | Al | Si | Al₂O₃ |
|---|---|---|---|---|
| Δh° kJ/mol | −859.3 | 0 | 0 | −1676.8 |
| S° J/mol Kelvin | 42.09 | 28.31 | ? | ? |
| Cₚ J/mol Kelvin | 44.43 | 24.34 | ? | ? |

ΔH=0+8·(−1676.8)−12·(−859.3)−0 kJ=−3,102.8 kJ

Equation (II) is thus a reaction which is exothermic at 25° C. because ΔH<0.
3) Combustion of Silicon with Nitrogen:

The following thermodynamic variables apply to equation (IV):

12Si+8N₂→4Si₃N₄ (IV)

| | Si | N₂ (g) | Si₃N₄ |
|---|---|---|---|
| Δh° kJ/mol | 0 | 0 | −750.0 |
| S° J/mol Kelvin | ? | 191.5 | 95.4 |
| Cₚ J/mol Kelvin | ? | 29.08 | 99.87 |

ΔH=4(−750.0)+0+0 kJ=−3,000.0 kJ

Equation (III) is thus a reaction which is exothermic at 25° C. because ΔH<0.

### 4) Reduction of Aluminum Oxide to Aluminum:

The following thermodynamic variables apply to equation (V):

8Al₂O₃→168Al+12O₂ (V)

| | Al₂O₃ | Al | O₂ |
|---|---|---|---|
| Δh° jK/mol | −1676.8 | 0 | 0 (g) |
| S° J/mol Kelvin | ? | 28.31 | 205.0 (g) |
| Cₚ J/mol Kelvin | ? | 24.34 | 29.36 (g) |

ΔH=0+0+8·(−1676.8)−0 kJ/mol=+13,414.4 kJ

Equation (IV) is thus a reaction which runs in a highly endothelinic manner at room temperature because ΔH>>0.

### 5) Energy Balances for the Cycle Process at 25° C. (298 K):

12SiO₂+2C₁₀H₂₂+31O₂→12SiO₂+20CO₂+22H₂O ΔH=−12,695.6 KJ (I)

2C₁₀H₂₂+31O₂→20CO₂+22H₂O (II)

12SiO₂+16Al→12Si+8Al₂O₃ ΔH=−3,102.8 kJ (III)

12Si+8N₂→4Si₃N₄ ΔH=−3,000.0 kJ (IV)

8Al₂O₃→168Al+12O₂ ΔH=+13,414.4 kJ (V)

ΔH=−5,384.0 kJ

An exothermic heat amount of 5,384 kJ therefore remains in the cycle process at room temperature.

The production of silicon carbide and silicon nitride can also be combined with each other as follows. Elementary silicon which is produced in a reduction process (e.g. by adding aluminum to silicon dioxide) is used. A part of the silicon can be used in order to bind carbon dioxide which is produced for example during the heating of the silicon dioxide solid. In this binding process, silicon carbide is produced from the silicon and CO₂ in a slightly exothermic process. The remainder of the silicon can be converted into silicon nitride together with the nitrogen gas as a reaction partner. This process is highly exothermic.

A part of the thermal energy which is obtained in these exothermic processes can be used to prepare or provide the reducing agent. Energy can be used for example to produce aluminum from aluminum oxide (with heat and/or supply of current). The processes are preferably separated from each other spatially.

The processes in accordance with the invention are characterized in that they can be used advantageously in order to combine the various substances which are thus obtained so that ALON (a light and transparent material) can be produced. The powdery materials are mixed and heated in order to produce ALON.

1. A process for providing silicon solid compounds from silicon dioxide solid compounds comprising the following steps:
a) introducing silicon dioxide solid compound into a combustion zone;
b) heating the combustion zone together with the silicon dioxide solid compound;
c) converting silicon dioxide from the silicon dioxide solid compound into silicon (Si₂), wherein a reducing agent is supplied in order to remove the oxygen from the silicon dioxide;
d) injecting a gaseous reaction partner in order to produce silicon solid compound from the silicon (Si₂);
e) using a portion of the thermal energy which is released during the production of the silicon solid compound in order to produce the reducing agent in a reduction process.

2. A process according to claim 1, wherein the silicon compound is silicon nitride (Si₃N₄) and nitrogen used in step d) as a gaseous reaction partner.

3. A process according to claim 1, wherein the silicon solid compound is silicon carbide and gaseous CO₂ which is used in step d) as a gaseous reaction partner.

4. A process according to claim 1, wherein liquid or powdery aluminum is added as a reducing agent in step c).

5. A process according to claim 4, wherein the liquid or powdery aluminum is provided from bauxite or Al₂O₃ in a preceding step or a step progressing at the same time.

6. A process according to claim 2, wherein atomic oxygen is used in order to radicalize the nitrogen.

7. A process according to claim 2, wherein the reaction for the preparation of the silicon nitride (Si₃N₄) occurs in a highly exothermic way and the resulting waste heat is used for generating electric power.

8. A process according to claim 7, wherein the resulting waste heat is used in an adjacent zone for melting Al₂O₃ (e.g. from bauxite).

9. A process according to claim 1, wherein different endothermic and exothermic reactions are thermally coupled.

10. A process according to claim 1, wherein one or several of the steps are carried out in a pyrolysis furnace.

11. A process according to claim 10, wherein the pyrolysis furnace is provided with a high-temperature resistant coating.
